(19) United States
(12) Patent Application Publication
(10) Pub. No.: US 2006/0159879 A1
(43) Pub. Date: Jul. 20, 2006

(54) Multi-layer film structure especially multi-layer film label structure

(76) Inventor: Peter Heymann, Duesseldorf (DE)

Correspondence Address: Martin A Farber, 866 United Nations Plaza, Suite 473, New York, NY, 10017, US

(21) Appl. No.: 10/526,642

(22) PCT Filed: Sep. 9, 2003
(86) PCT No.: PCT/EP03/09995

§ 371 Date: Nov. 17, 2005

(30) Foreign Application Priority Data
Sep. 9, 2002 (EP) 02020165.3

(51) Int. Cl. B32B 27/32; B32B 27/08

(52) U.S. Cl. 428/35.7; 428/500; 428/220; 428/910; 156/79; 264/45.9

(57) ABSTRACT

The invention is concerned with a mufti-layer film structure (1), especially film label-structure having a shrinkability, produced preferably in the coextrusion process, with a first (3) and a second (4) outer layer and a third inner layer (2) between the first (3) and second (4) layer, all layers consisting essentially of polystyrene. In order to achieve an advantageous label stock, the invention proposes, that the first (3) and second (4) layer are by weight approximately 50-75% of the overall weight of the label-structure, that the overall thickness is in the range of 0.5 to at least 4 mils (0.012 to 0.102 mm) and that the first (3) and second (4) layer consist of general, purpose styrenic resin, whereas the third layer (2) is a modified tough polystyrene, such as “K-resin” of Philipps Petroleum Chemicals.

The invention is concerned with a multi-layer film structure, especially label-structure for labeling of bottles, glass bottles as well as plastic bottles, cans, jars and other containers. Such structures are already known in a high number of various combinations. A reference is made for example to EP-B1-84360, EP-B1-450331, GB-PS-1383622, GB-PS-1284766, U.S. Pat. No. 4,207,402, U.S. Pat. No. 4,904,324, DE-OS-43 15 6, EP-A1-612 613, U.S. Pat. No. 3,275,720 and Belgium patent 706 673.

The film structure, especially printed with for example trade names, user directions or other information, may be used for applications such as wrapping of articles, printed sheets, for example for lying under dishes on the table. The multi-layer film label-structure will be used for labeling of bottles, jars and so on.

All the known label-structures have certain advantages and disadvantages related to the demands especially for labeling purposes. There is the need for a transparent label as well as for an opaque label. Further, a good printability is highly desired. Also, the label should be able to be applied on a shrink or a non-shrink application. For a seaming of the label edges and its application to a container as mentioned above, it should be possible, to use glue or solvent or a heat sealing technique with possibly the same label stock. With respect to production demands, it should be possible, to produce the label in different modifications without the need to change too much of the production line or even to use different production lines. Further aspects are a desired ease of recycling and broad application to various printing processes. The label surface should be possibly such that for printing no or nearly no pre-treatment is required.

Based on this, the invention is concerned with the technical problem to provide for a concept of a multi-layer film structure, especially a film label-structure, being able to fulfil most if not all requirements for todays demands, especially labeling demands, being producible with generally the same equipment with transparent and opague properties, whereby possibly the overall costs of the structure are in the lower region.

This technical problem is first solved by the concept of claim 1, providing the concept of a multi-layer film label-structure, having a shrinkability, with a first and a second outer layer and a third inner layer between the first and second layer, all layers consisting essentially of polystyrene, whereby the overall thickness is in the range of 0.5 to at least 4 mils (0.012 to 0.102 mm) and the first and second layer do consist of general purpose styrenic resins whereas the third layer does consist of a modified tough polystyrene with modifiers such as butadiene and/or acrylat and with such an amount on those modifiers, that the third layer may function as a carrier layer for the first and second layer, in terms of allowing to produce the label-structure according to the coextrusion process. The overall thickness may be especially up to 0.03; or between the latter value and up to 0.06; or between the latter value and up to 0.09; or between the latter value and up to 0.10; or between the latter value and up to 0.11; or between the latter value and up to 0.12. This includes also the so called bubble blowing method. The coextrusion technology is preferred because of the basic cost and ease of operation and control. In the coextrusion technique the preferred practice is to employ a coextrusion die which has an annular circular opening and the composite structure is initially formed as a tubular shape by what is referred to in the art as “blown tubular bubble” technique. This type of coextrusion die is set fourth in SPE Journal, November 1969, Volume 25, page 4, entitled “Coextrusion of Blown Film Lamination”. In this known coextrusion technique, the circular opening is fed from two or more independent extruders and, in the particular instance the outer layers could be supplied from separate or a common extruder. The middle layer would be formed from a different extruder than used for the other layers. The tubular member exiting from the die is blown into a bubble by conventional “bubble” forming techniques including air cooling of the inner and outer surface of the bubble. The bubble is pulled away from the die in the vertical direction as the bubble cools stresses are imparted which form shrink properties to the label in the machine direction. By balancing the machine direction pull and the bubble blow-up, the desired machine direction and cross direction properties for shrinking can be controlled. Preferably, the shrinkability is of a four to one ratio or more (f.e. five to one, six to one, seven to one, eight to one). Also the further known coextrusion technique may be employed, i.e. the flat die extrusion process.

In the case of opaque design, pigments and additives to form a gas at extrusion temperature can be added to form a cellular (and lower density) opaque structure. The term “general purpose styrenic resins” refers to styrenic resins with little or no rubber modification. Also it is refered to so called crystal polystyrene or pure polystyrene or a polystyrene having very low additives or modifiers respectivly. The term “modified tough polystyrene” refers especially to highly rubber modified polystyrene, such as known as high impact polystyrene or medium impact polystyrene. The letter once are especially of advantage for the opaque version of the structure. Further, with respect to the modified tough polystyrenes are known so called styrolux and “K-resin”. “K-resin” is a product of Philipps Petroleum Chemical. Styrolux is a styrene butadiene block copolymere, having for example an amount of 20 to 28% butadiene. Styrolux is a product and a trade name of BASF.

The term “modified tough polystyrene” refers also to polystyrene with an additive as described in the European patent 0 983 308 B1. The disclosure of this European patent is imported by reference in the present application. This also in respect of features described in the said European patent to be incorporated in claims of the present application.

The advantage of the described concept is first the flexibility of producing a transparent or opaque version. Second is the very good properties of the outer layers, consisting of general purpose styrenic resins or polystyrene, especially in terms of printability. These are especially achieved by voiding particles such as gels, often present on the surface of 1% highly modified styrenes, such as styrolux film. Further, with respect to shrink applications. Whereas shrink applications are very often in the wrapping, especially labeling technique, it is of advantage that the label-structure described here may be also without modifications be applied in non-shrink applications. Still further is also of advantage, that such label stock can be produced with a high amount of regular, general purpose polystyrene, being available currently at comparatively low costs, whereas the additives such as butadiene, acrylat and so on are reduced compared to known structures, especially label-structures, based on polystyrene. It is also of advantage that a structure, especially a label-structure, according to a concept described here, both transparent and opaque, may be produced in a coextrusion process or a so called bubble blowing process, preferably single bubble process, or double bubble process. It is not necessary to use the very capital intensive tenter frame process. The bubble blowing or coextrusion process may also be a horizontal process, whereas the vertical process is preferred. In further detail for providing the opaque version, it is preferred, that the third layer is pigmented or voided or foamed. With respect to the foaming, it is also preferred, to foam on a chemically base, whereas it is also possible, to foam with inert additives. Beside this also the flat die coextrusion technique is useable with advantage. The voiding or foaming step provides two desirable features to the structure, especially label-structure, lower density due to the void pockets and light scattering of transmitted light improving opacity. Obviously, voiding is also of advantage in terms of weight. For the general concept, the first and second layer shall provide from 10 to 75% of the overall weight/thickness of the label-structure. This is in more detail a share of 40 to 75% (especially up to 45% or between the latter value and up to 50%; or between the latter value and up to 55%, or between the latter value and up to 60%; or between the latter value and up to 65%; or between the latter value and up to 70%; or between the latter value and up to 75%) in case the third layer is transparent and therefore the hole structure, especially label-structure, is transparent, as the first and second layer are in all versions transparent. And it is in the range of 10 to 50% (especially up to 15% or between the latter value and up to 20%; or between the latter value and up to 25%; or between the latter value and up to 30%; or between the latter value and up to 35%; or between the latter value and up to 40%; or between the latter value and up to 45%; or between the latter value and up to 50%) in case the third layer is opaque. The skin layers or outer layers respectively are balanced and form the bulk of the material being used.

Whereas it is presently preferred, to have always and at least three layer structure, especially label-structure, the inventive concept does also refer to a only two layer system. In such a two layer system, one layer is produced according to the mentioned first or second layer and the second layer is produced according to the mentioned third layer.

In further detail, it is also possible, to have such structure, especially label-structure, recycled and to have the recycled material combined to the third layer or even incorporated in a fourth, preferably inner layer. As to this it is not essential, but preferred, that the recycled material does consist of the same label stock. Since the materials used to produce the structure, especially label-structure, described here are compatible, the generated out of specification stock, especially label stock, and trim can be recycled into the outer layer of the opaque label stock by readjusting the additives as mentioned, especially the amount of virgin “K” resin used in the third layer. The recycled material can also be placed in a separate internal layer.

Subject of the invention is also a method for producing a polystyrene based multi-layer structure, especially label-structure, with a middle layer (third layer) of tough polystyrene, having additives such as butadiene and acrylat or consisting of so called “K-resin” whereby is focused on that in a first step one or two outer layers are put on the middle layer preferably by coextrusion, such outer layers consisting essentially of general purpose styrenic resins and that the so built label-structure will be in a second step blown up, whereby the middle layer functions as carrier in terms of toughness for the outer layers. The blowing up may be carried out in a so called bubble blowing process. As to further details of the method it is referred to the above description.

Further subject matter of the invention is also an article such as a glass container, labeled with a multi-layer label-structure in one of the embodiments as described before. The container may also be a metal container or a plastic container.

Of importance is for all products and methods described that the srinkablity is in machine direction (MD). Especially only in machine direction. This means in extrusion direction. “Only” in machine direction does of course mean that there must be always also some little shrinkability in cross direction (CD) relative to the machine direction. However, this CD shrinkability is as low as possible, f.e. in the range 1 to 10% (2%, 3%, 4%, 5%, 6%, 7%, 8%, 9% or even in between such values) of the shrinkablity in MD. Therefore, in the following it is refered in so far to a shrinkability “almost” only in machine direction.

In the following, the invention is described as example in terms of a film label-structure product, with reference to the accompaning drawings, wherein shows:

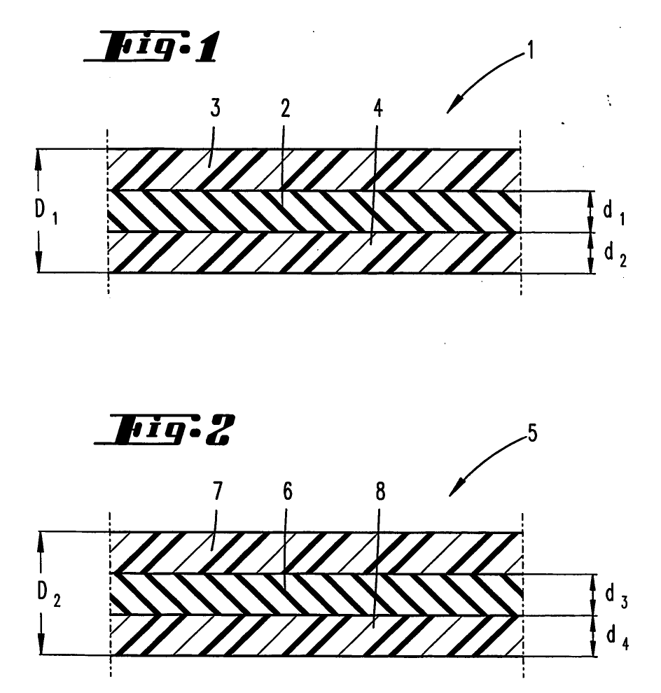

FIG. 1 a vertical sectional view of a first multi-layer film label-structure;

FIG. 2 a view according to FIG. 1 of a second label-structure;

Described and shown is, first with reference to FIG. 1, a cross sectional view of a first multi-layer film label-structure 1 with a middle layer 2 and two outer layers 3, 4. The label-structure is transparent.

The middle layer 2 does consist of polystyrene, having additives such as butadiene and/or acrylat. More specifically, the middle layer 2 may consist of a so called “K-resin”, as it is produced by Philipps Petroleum Chemicals. The middle layer 2 may also consist of a mixture of approximatly 50% polystyrene and 50% styrolux. “Styrolux” refers to a styrene butadiene block copolymere having an amount of butadiene from 20 to 28%. The outer layers 3, 4 are nearly completly or up to about 75% of pure, so called crystal polystyrene. The remainder of the outer layers may also be additives such as butadiene and/or acrylat.

The total thickness D1 of a label-structure according to FIG. 1 be about 0.5 to at least 4 mils (0.012 to 0.102 mm). The thickness can even be also essentially higher as 4 mils. The thickness d1 of the middle layer 2 is about halve of D1 (40%, 45%, 50%, 55% or 60% of d1 or even in between those values) or less, whereas the thickness d2 of the outer layer 3 or the outer layer 4 is about one fourth (30%, 28%, 26%, 24%, 22%; 20% or even in between those values) of the overall thickness D1.

The transparency of a label-structure according to FIG. 1 is much higher than up to now known for a mono layer label. Further, the scratch resistance is improved. Also the printability is improved.

The label-structure 5 according to FIG. 2 is opaque. The middle layer 6 of the label-structure 5 does consist of polystyrene, basically as described before. However, the middle layer 6 is foamed or voided or pigmented, such, that the transparency of polystyrene is suspended. The two outer layers 7 and 8 do again consist of pure, crystal polystyrene or slightly modified polystyrene, also as described above with reference to FIG. 1. One or both outer layers are printed with f.e. trade names of the product, information to use the product and so on.

The overall thickness is about 7 μm. The thickness may vary within the ranges described above.

The features of the invention disclosed in the preceding description, the drawings and the claims may be individually as well as in a free combination of importance for the realization of the invention. In the disclosure of the invention herewith also the disclosure of the appropriate/attached priority document (copy of the prior application) are enclosed with their full content.

1. Preferably co-extruded multi-layer structure, especially multi-layer film structure, with a first and a second outer layer and a third inner layer between the first and second layer, all layers consisting essentially of polystyrene, whereby the overall thickness is in the range of 0.5 to at least 4 mils (0.012 to 0.102 mm or more) and the first and second layer do consist of general purpose styrenic resin whereas the third layer does consist of a modified tough polystyrene with modifiers such as butadiene and/or acrylat and/or similar modifiers, and with such an amount of those modifiers, that the third layer may function as a carrier layer for the first and second layer, in terms of allowing to produce the label-structure according to the coextrusion process.

2. Film structure according to claim 1, characterized by a shrinkablity in extrusion direction.

3. Structure according to one or more of the preceding claims or especially to one of them, characterized in that the third layer is pigmented.

4. Structure according to one or more of the preceding claims or especially to one of them, characterized in that the third layer is voided.

5. Structure according to one or more of the preceding claims or especially to one of them, characterized in that the third layer is foamed.

6. Structure according to one or more of the preceding claims or especially to one of them, characterized in that the first and second layers do provide ca. 25 to ca. 75% of the overall weight/thickness.

7. Structure according to one or more of the proceding claims or especially to one of them, characterized in that the first and second layer do provide ca. 50 to ca. 75% of the overall weight/thickness and that the third layer is tranparent.

8. Structure according to one or more of the proceding claims or especially to one of them, characterized in that the first and the second layer do provide ca. 25 to ca. 50% of the overall weight/thickness and that the third layer is opaque.

9. Structure according to one or more of the preceding claims or especially to one of them, characterized in that the shrinkability is almost only present in extrusion direction.

10. Multi-layer film structure, especially multi-layer film label structure, having a shrinkability in extrusion direction, produced in the coextrusion process, with a first and a second outer layer and a third inner layer between the first and second layer, all layers consisting essentially of polystyrene, characterized in that the first and second layer are by weight approximately 50-75% of the overall weight of the label-structure, that the overall thickness is in the range of 0.5 to at least 4 mils (0.012 to 0.102 mm) and that the first and second layer consist of general purpose styrenic resin, whereas the third layer is a modified tough polystyrene, such as “K-resin” of Philipps Petroleum Chemicals.

11. Multi-layer film structure according to claim 10, characterized in that the shrinkabiliy is present only in extrusion direction.

12. Multi-layer film structure, especially multi-layer film label-structure, produced preferably in the coextrusion process, with a first and second outer layer and a third inner layer between the first and second layer, all layers consisting essentially of general purpose styrenic resin, characterized in that the first and second layer are by weight approximately 25-50% of the overall weight of the structure, that the overall thickness of the structure is in the range of 0.5 to at least 4 mils (0.012 to 0.102 mm or more), that the first and second layer do consist of general purpose styrenic resin, whereas the third layer is a modified tough polystyrene such as “K-resin” of Philipps Petroleum Chemicals, and that the third layer is foamed, voided or pigmented in order to give the structure opaque properties.

13. Multi-layer film structure according to claim 11, characterized by a shrinkability in extrusion direction.

14. Multi-layer film structure according to claim 12 or 13, characterized in that a further inner layer (fourth layer) is provided and that the fourth layer does consist of recycled material.

15. Multi-layer film structure according to one of the claims 12 to 14, characterized in that the srinkability is almost only in extrusion direction.

16. Method for producing a polystyrene based multi-layer structure, with a middle layer (third layer) of tough polystyrene, having additives such as butadiene and/or acrylat or consisting of so called “K-resin”, characterized in that in a first step one or two outer layers are put on the middle layer preferably by coextrusion, such outer layers consisting of general purpose styrenic resin, and that the so built structure will be in a second step blown up preferably in a bubble blowing process whereby the middle layer functions as a carrier in term of toughness for the outer layers.

17. Method according to claim 16, characterized by a shrinkability only in extrusion direction.

18. Container, such as glass container, plastic container, metal container, labeled with a multi-layer label-structure having one or more of the features mentioned for the structure in one or more of the preceding claims or produced according to the claimed method.
